(19) United States
(12) Patent Application Publication
(10) Pub. No.: US 2026/0366634 A1
(43) Pub. Date: Nov. 19, 2026

(54) Double Block and Bleed Fluid/Gas Flow-Control Assembly

(71) Applicant: Ronald E. SMITH, Palmer, AK (US)

(72) Inventor: Ronald E. SMITH, Palmer, AK (US)

(21) Appl. No.: 19/209,765

(22) Filed: May 15, 2025

(51) Int. Cl. F16K 17/02

(52) U.S. Cl. CPC F16K 17/02

(57) ABSTRACT

The disclosed double block and bleed valve assembly is useful for flow-control in a fluid/gas flow line. The double block and bleed valve device has three main sections: a flow-control section, and two combination shut-off/oneway valve sections. The flow-control section exemplified herein is a choke type valve having an inlet port and an outlet port. A shut-off/oneway valve section is attached in-line with the flow-control section's inlet and outlet ports. Each shut-off/oneway valve section has a flow shut-off component enabling blocking, purging, pre-charging of fluid/gas through the flow-control section, and a oneway flow valve component. The combination of the flow-control section and the two purgeble shut-off/oneway valve sections allows the flow control section to be isolated and accessed for servicing, repair, replacement and recharging without risk of inadvertent release or spillage of the fluent from the flow control section.

### FIELD OF THE INVENTION

The present invention is in the field of Fluid Handling Systems (Class/Subclass 137/561), wherein the fluid handling system has means for confining a fluent material in a flow path during its flow, and controlling its flow or potential flow. More specifically, the present invention relates to such systems having a single flow path with two or more spaced valves, flow controllers or closures therein through which the fluent material passes serially (Subclass 613), wherein at least one valve is biased by spring means (Subclass 614.14).

### SUMMARY OF THE INVENTION

The present invention is a double block and bleed flow-control assembly for use in a fluid or gas flow line. The present flow-control assembly is a device having three main components: a flow-control section, an upstream shut-off/oneway flow section, and a down stream shut-off/oneway flow section. The flow-control section provides for monitoring or controlling some parameter of fluid/gas flow of the pipeline in which it is installed. The flow-control feature of the flow-control section is illustrated herein as being a choke type valve and has an upstream flow inlet port and a down stream flow outlet port.

A shut-off/oneway section is installed on the flow-control section at the inlet port as an inlet flow shut-off means, and at the outlet port as a separate outlet flow shut-off section means. Each shut-off/oneway section has a flow shut-off component enabling blocking, charging and passage of fluid/gas flow to into or out of the flow-control section, and a oneway flow component enabling one way fluid/gas flow through the flow-control section. The combination of the flow-control section with the two shut-off sections accomplish the double block and bleed flow-control assembly of the present invention for use in a fluid/gas flow line.

An object of the present invention is to provide a means for servicing or replacing the flow-control section of the assembly, and reducing/eliminating the risk of leakage or spillage of flow-line content during the process. Additionally, the present invention allows the flow-control to be recharged after servicing, before applying line pressure of the pipeline to serviced/newly installed flow-control section. Also, the double block and bleed flow-control assembly is useful if the flow-control section of the assembly does not have or is not is a preferred flow shut-off means for flow in the pipeline.

### BRIEF DESCRIPTION OF THE DRAWINGS

FIG. 1 is a schematic illustrating a configuration of the main components of a double block and bleed fluid flow-control assembly.

FIG. 2 is a cross-sectional side plan view of a shut-off section 14b of FIG. 1.

FIGS. 3A-3C represent cross-sectional, top plan views through the axis of rotation of a ball-valve in the shut-off component of the present invention, illustrating orientation of the flow bores of the ball valve in open-flow (3A), flow-closed (3B), and charge/bypass flow conditions.

FIGS. 4A & 4B are partial cross-sectional schematics of a oneway valve components, showing its operation.

### DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix. Note that the figures and portions thereof are not necessarily presented to scale.

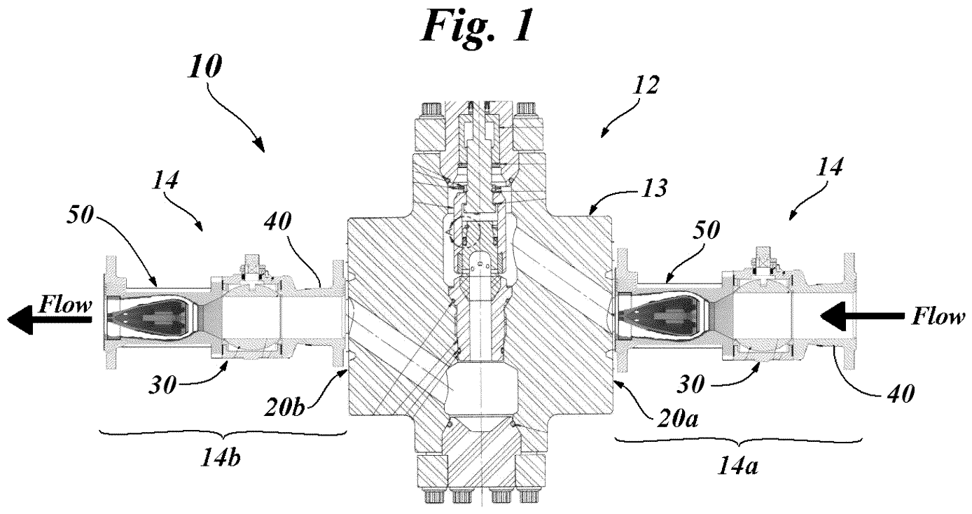

The present invention is a double block and bleed fluid flow-control assembly 10. In a preferred embodiment illustrated in FIG. 1, the flow-control assembly 10 has three main functional sections: a flow-control section 12, and two shut-off sections 14—an inlet shut-off section component 14a and an outlet shut-off section component 14b. In this embodiment, the present invention is exemplified as having each of its main functional sections represented as a separate element of the flow-control assembly 10. However, it is anticipated that the present invention can be practiced having some or all of the main functional components integrally dispose in a shared housing.

### Flow-Control Section

FIG. 1 illustrates an exemplary embodiment of the present flow-control assembly 10. In this embodiment, the flow-control section 12 of the flow-control assembly 10 is a fluid/gas flow control valve of some type. For exemplary purposes herein, the flow-control section component 12 of the embodiments is a choke valve 13. A choke valve, sometimes also known as “choker valve,” is a type of control valve used (e.g., in oil and gas production) to control the flow features of fluids or gases in a conduit. For example, choke valves are used to reduce flow pressure from a source or reservoir, to regulate the down stream flow/pressure in fluid/gas flow lines, pipes and conduits. See https://enggcyclopedia.com/2012/03/choke-valves/, accessed on 24 Apr. 2023. The flow control section 12 has an inlet port 20a and an outlet port 20b.

### Shut-off/oneway Sections

As the name indicates, the shut-off/oneway valve sections 14 provides means for controlling flow through the shut-off/one way sections 14a & 14b. In the present figures, the inlet section 14a and the outlet section 14b are similar, with both sections comprising a combination of a shut-off means 30 and a oneway flow means 50. A coupler section 40 is also shown in the figures. A shut-off/oneway valve section 14 is installed at both the inlet port 20a and at the outlet port 20b of the flow-control section component 12 to accomplish the oneway fluid flow and the flow shut-off limitations of the double block and bleed flow-control assembly 10. An example of how this configuration of the double block and bleed fluid flow-control assembly 10 can be accomplished is shown in FIGS. 1 & 2.

The shut-off/oneway valve sections 14 as exemplified in FIG. 1 are substantially the same, with each shut-off section having a shut-off valve component 30, a oneway valve component 50. Additionally shown is an optional coupler component 40. A coupler component 40 may be positioned anywhere in the flow-control assembly 10 by one of skill in the art to accomplish specific configuration desired by a user, such as to provide a mount for a purge/charging valve 42 or similar fitting. In this embodiment, inlet shut-off section 14a and outlet shut-off section 14b are interchangeable. However, this is not a necessary limitation of the present invention. For example, in an alternative embodiment the outlet shut-off section section 14b can be practiced without a oneway flow means (not shown), depending on the expected operational parameters of the flow line in which the overall assembly 10 is installed. For example, if there is no risk of back flow or a line pressure spike from down stream of the flow-control assembly 10, the oneway flow means 50 of the outlet shutoff section 14b may be eliminated.

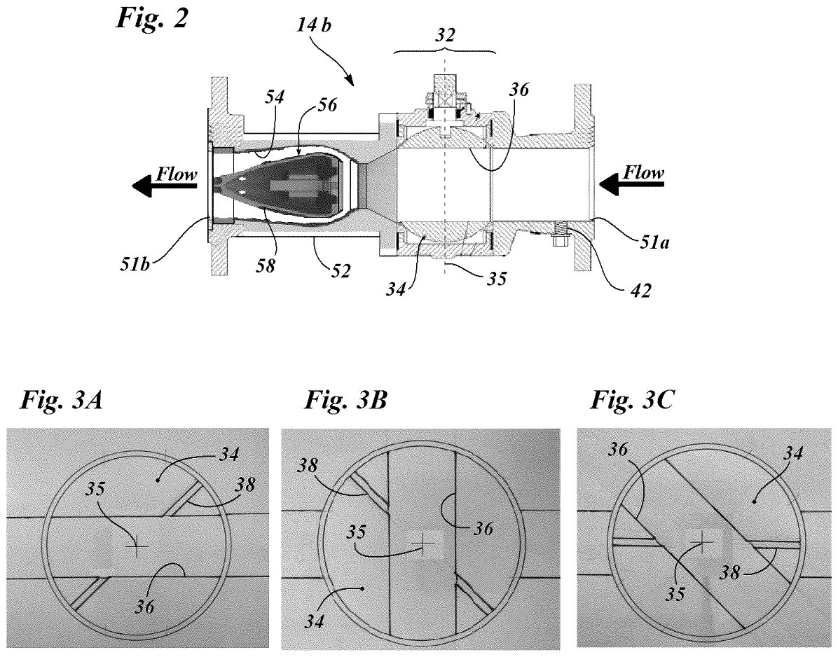

Shut-Off Means: As exemplified in FIG. 2, it can be seen that in this embodiment, the outlet shut-off section component 14b comprises two separable functional components: a flow shut-off component 30 and a oneway flow component 50. In the illustrated example of FIG. 2, the shut-off component 30 comprises a shutoff valve 32. The shutoff valve 32 illustrated is a ball valve having a spherical valve core 34 with an axis of rotation 35. A hollow main-bore 36, perpendicular to the axis of rotation 35, passes directly through the spherical core 34. Additionally, a much smaller charging/bypass bore 38 (see FIG. 3) in the same plane as, but offset from, the main-bore 36 also passes through the spherical core 34. Note, the charging/bypass bore 38 does not have to intersect the axis of rotation 35.

Alternatively, the shutoff valve 32 can comprise a plug/barrel valve (not shown) having a conical or cylindrical core (not shown), with a main-bore 36 and a charging/bypass bore 38 through it in a manner analogous to the spherical core 34. Generally, the core of a plug/barrel valve is larger than the core of a ball valve. There are other differences between ball valves and barrel/plug valves that can dictate whether one type is preferential in a specific application than the other. However, it is anticipated that both types of valves may be practiced in the present invention.

As illustrated in FIGS. 3A-3C, the shutoff valve 32 is selectable for three fluid/gas flow conditions: Open-Flow (FIG. 3A), Closed-Flow (FIG. 3B), and Charge/Bypass Flow (FIG. 3C). A Use Case detailing function and operation of the shutoff valve 32 is given below. Note that in FIGS. 1 & 2, the shutoff valve 32 is shown in the Open-Flow position.

Oneway Flow Means: Again referring to FIG. 1, each shut-off/oneway section 14 also comprises a oneway flow component 50 inline with the shut-off component 30. In the examples of FIGS. 1 & 2, the oneway flow component 50 has a flow-housing 52 with an upstream port, a down stream port 51b, a housing interior wall 54 and a housing interior space. The interior housing wall 54 and housing interior space are adapted to receive and securely mount a oneway valve assembly 56 within the flow-housing 52. The oneway valve assembly 56 includes a “shaped” valve-body 58, being shaped and surfaced to promote laminar flow around it and reduce ill effects of cavitation of the fluid/gas being transported through the oneway flow component 50. Likewise, the housing interior wall is adapted to closely receive the “shaped” valve-body 58, to promote laminar flow and to reduce ill effect of cavitation and flashing of the fluid/gas being transported through the oneway flow component 50. The combination of the shape of the interior housing wall 53 with the shape of the oneway valve body 58 defines the flow-space 60 of the oneway flow component 50. It is the displacement of the interior space 54 by the shape of the valve-body 58 when the oneway valve assembly 56 is received in the interior space that defines the flow-space 60 and promotes the laminar flow and the reduced cavitation and flashing characteristics of the oneway flow component 50.

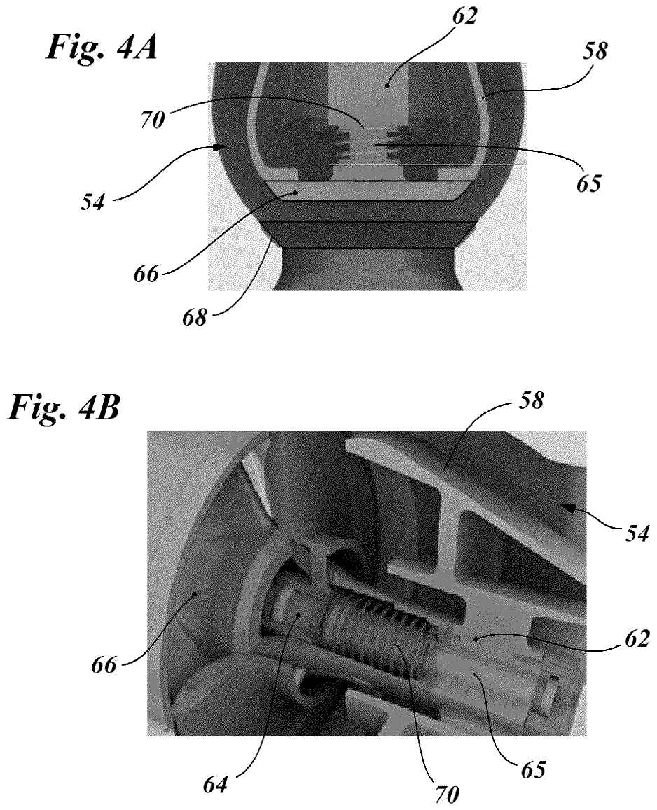

Additionally, as shown in FIG. 4, the valve-body 58 of the oneway valve assembly 56 incorporates a oneway valve mechanism 62. The oneway valve mechanism 62 has a valve member 64 received and slidable within the valve-body 58, the oneway-valve member 64 comprises a valve-stem 65 rod with a valve-face 66 disposed at rod's extendable end. A valve-seat 68 is disposed the inflow-port 51a in proximity of the valve-face 66 to receive valve-face 66 and seal the inflow-port 51a, preventing back flow of fluid/gas through the oneway flow component 50. In accomplishing this, a biasing means 70 provides a biasing force to tends to hold the oneway-valve member 64 normally in an extended and sealed condition under all negative/reverse flow conditions and under a minimal range of positive flow conditions. In the embodiments illustrated, the biasing force is accomplished using a spring biasing means 70.

In FIG. 4, the valve-seat 68 is a feature that is separate and not integral to the oneway valve assembly 56 or to the valve-body 58. However, in an alternative preferred embodiment, a oneway valve assembly 56b (not shown) integrally incorporates both the valve-body 58 (and oneway valve mechanism 62) with the valve-seat 68. In accomplishing this, the oneway valve assembly 56b comprises a mounting cylinder 57 having an cylinder interior surface 59. The valve-body 58 and the valve-seat 68 are both mounted in a fixed in proper relationship to each other to the interior surface 55 of the mounting cylinder 57. In this embodiment, the interior housing surface 55 that is adapted to complement the “torpedo shaped” valve-body 58, to promote laminar flow and to reduce ill effect of cavitation and flashing of the fluid/gas being transported through the oneway flow component 50. In this embodiment, the interior space 54 of the flow-housing 52 is adapted only to receive and securely mount the cylindrical exterior form factor of the oneway valve assembly 56a within it.

A pneumatic valve port (not shown) may be disposed on the housing 13 of the flow-control section 12, as practicable by one of skill in the art, to evacuate residual fluid or gas from the assembly when bleeding.

### Use Case

After installation or upon other need fluid charge the double block & bleed valve assembly, the Choke assembly is throttled, and the Shut-off assemblies (and any other open ports) are set to Closed.
To accomplish initial charging of the internal features of the full double block & bleed valve assembly, the ball-cock of the upstream shut-off valve is rotated to the Charge position, which opens a constricted fluid flow path through the call-cock. A reduced pressure “charging fluid flow” now impinges on the face of the flow-seal in the oneway valve. As the fluid pressure builds, the bias force holding the flow-seal of the oneway valve closed is overcome, and fluid flow at a reduced pressure and flow rate (relative to the full fluid flow stream) enters the fluid flow path of the Choke Valve and reduces bumping.
The charging fluid flow now charges/fills the fluid flow path of the choke valve assembly and enters the inflow port of the down stream shut-off valve, and impinges on the closed ball-cock of the valve.
Once the entire double block & bleed valve assembly has been charged and comes to flow line pressure, the choke valve may be adjusted to a desired initial setting.
The upstream shut-off valve is moved from charge to full open.
The down stream shut-off valve may be set to charge and then to full open, as desired.
A reverse procedure may be followed to shut down and bleed the double block & bleed valve assembly as is practicable to one of skill in the art.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

1. A double block and bleed flow-control assembly (10) for use in a fluid/gas flow line, the flow-control assembly (10) comprising: a flow-control section (12) to regulate fluid/gas flow in the flow line, and two shut-off sections (14) to selectably block, charge or open the flow-control assembly (10) to fluid/gas flow of the flow line;
the flow-control section (12) for regulating fluid/gas flow in the flow line, the flow-control section (12) having an inlet 20a port and an outlet port 20b;
the shut-off sections (14) being installed on the flow-control section (12) at the inlet port 20a as an inlet shut-off means 14a and at the outlet port 20b as an outlet shut-off section means 14b, and each shut-off section 14 further comprising a flow shut-off component 30 enabling blocking, charging and allowing fluid/gas flow to the flow-control assembly (10), and a oneway flow component 50 enabling one way fluid/gas flow through the flow-control assembly (10); and
the combination of the flow-control section (12) and the two shut-off sections (14) accomplishing said double block and bleed flow-control assembly (10) for use in a fluid/gas flow line.

2. The double block and bleed flow-control assembly (10) of claim 1 wherein: the flow-control section (12) essentially consists a choke type valve.
